(19) United States
(12) Patent Application Publication
(10) Pub. No.: US 2005/0145117 A1
(43) Pub. Date: Jul. 7, 2005

(54) Mechanical press with controllable mechanism

(76) Inventors: Ruxu Du, Hong Kong (CN); Weizhong Guo, Shanghai (CN); Kin Yueng, Hong Kong (CN)

Correspondence Address: Law Offices of C. George Yu, Second Floor; PMB 2008, 12707 High Bluff Drive, San Diego, CA, 92130, US

(21) Appl. No.: 10/934,107

(22) Filed: Sep. 3, 2004

Related U.S. Application Data
(60) Provisional application No. 60/499,931, filed on Sep. 3, 2003.

(51) Int. Cl. B30B 15/14

(52) U.S. Cl. 100/281

(57) ABSTRACT

According to an embodiment of the invention, a mechanical press includes a transmission that comprises a first transmission and a second transmission coupled to the first transmission. The first transmission is for receiving mechanical movement from a first motor and to transmit mechanical movement to a ram. The second transmission is for modifying configuration of the first transmission in response to mechanical movement received from a second motor, and a profile of movement of the ram over a pressing cycle is affected by a profile of movement from the second motor over the pressing cycle.

### RELATED APPLICATION(S)

The present patent application is related to and claims the benefit of priority from commonly-owned, co-pending U.S. Provisional Patent Application No. 60/499,931, filed on Sep. 3, 2003, entitled “Mechanical Press With Controllable Mechanism”, which is hereby incorporated by reference in its entirety for all purposes.

### FIELD OF THE INVENTION

The present invention relates to presses, for example, presses for shaping metal or other materials. More particularly, the present invention relates to presses having operating characteristics that are easy to alter, for example, via programming.

### BACKGROUND

Conventional metal forming presses can be divided into two categories: mechanical presses and hydraulic presses. The former is fast (high speed presses may reach up to several thousand shots per minute) and energy efficient (large flywheels can ease impulsive forces) but lacks flexibility. On the other hand, hydraulic presses are flexible (their motions can be programmed) and accurate, but are expensive to build and to operate (flywheels cannot be used and high powered hydraulic motors (e.g., linear actuators) are needed and hydraulic motors are slow). More recently, mechanical presses have been introduced that are driven by servomotors. Such presses can perform as flexibly as hydraulic presses with high speed. Nevertheless, they are extremely expensive to build and to operate (large expensive servomotors are needed and no flywheels or only relatively small flywheels are used).

Due to cost and productivity concerns, the mechanical presses are dominant in general factories. To achieve the desired performance, various designs for mechanical presses have been made mainly based on such philosophy as appending multiple linkages that apparently complicate the machines. Moreover, these designs are not controllable by re-programming or numerical control.

Generally, mechanical presses employ a conventional construction that includes a frame structure having a crown and a bed portion and which supports a slide in a manner enabling linear movement toward and away from the bed. A press drive assembly including a motor and a crankshaft is arranged to convert rotary-oscillatory motion into the rectilinear linear motion of the slide. These press machines are widely used for a variety of workpiece operations employing a large selection of die sets, with the press machine varying considerably in size and available tonnage depending on its intended use.

Conventional mechanical presses are provided a clutch which imparts rotational motion to a crankshaft. The crankshaft translates the rotational motion of the crankshaft into linear mechanical motion that is transmitted to the punch through a connecting arm. One complete rotation of the crankshaft produces one complete linear motion of the punch.

Depending upon the type of drive mechanism utilized, the punch can maintain a constant velocity or an irregular velocity. Irregular velocity is advantageous in press applications wherein reduction of the punch velocity near the bottom of the stroke is required so that the draw speed of the material is not exceeded. Presses which utilize different arrangements to produce irregular velocity are known in the art.

The ability to alter the drive mechanism of a mechanical press from a slider crank drive to differing link drive arrangements is advantageous in that one particular press may be altered to perform different operations. Modular unit presses can allow for differing drive mechanisms. Different modular units may be used to create different link drive arrangements and geometries. That is to say, link drive arrangements will be varied depending upon the modular unit chosen. The ability to vary the drive assembly of a press makes the press more versatile in its application. However, having to stop the press to make this reconfiguration is problematic.

### SUMMARY OF THE INVENTION

What is needed are presses that are efficient and suitable for a variety of tasks.

According to an embodiment of the present invention, a press comprises: a first motor that produces mechanical movement; a second motor that produces mechanical movement; and a transmission configured to convey mechanical movement to a ram from mechanical movement received by the transmission from at least the first motor, the conveying being responsive to mechanical movement received by the transmission from the second motor; wherein the second motor is configured to provide mechanical movement that is controllably variable during a pressing cycle.

According to an embodiment of the present invention, there is a transmission for a mechanical press. The transmission comprises: a first transmission for receiving mechanical movement from a first motor and to transmit mechanical movement to a ram; and a second transmission for modifying configuration of the first transmission in response to mechanical movement received from a second motor wherein a profile of movement of the ram over a pressing cycle is affected by a profile of movement from the second motor over the pressing cycle.

According to an embodiment of the present invention, there is a method for performing a pressing operation. The method comprises the acts of: providing a first mechanical motion; conveying mechanical energy from at least the first mechanical motion to a ram via a transmission configuration; and providing a controllable second mechanical motion that alters the transmission configuration to control the motion characteristics of the ram, the second mechanical motion being distinct from the first mechanical motion.

According to an embodiment of the present invention, there is a method for constructing at least a portion of a mechanical press. The method comprises the acts of: providing a first transmission configured to receive mechanical movement from a first motor and to transmit mechanical movement to a ram; and providing a second transmission configured to modify configuration of the first transmission in response to mechanical movement received from a second motor wherein a profile of movement of the ram over a pressing cycle would be affected by a profile of movement from the second motor over the pressing cycle.

### BRIEF DESCRIPTION OF THE DRAWINGS

In order to more extensively describe some embodiment(s) of the present invention, reference is made to the accompanying drawings. These drawings are not to be considered limitations in the scope of the invention, but are merely illustrative.

FIG. 1 is a schematic diagram of a press configuration, according to the prior art.

FIG. 2 is a schematic diagram of a press configuration, according to an embodiment of the present invention.

FIGS. 3A and 3B are schematic diagrams of embodiments of the press configuration of FIG. 2.

FIG. 4 is a schematic flow chart that illustrates a method for providing a press according to an embodiment of the present invention.

FIG. 5 is a schematic flow chart that illustrates a method for stamping a workpiece according to an embodiment of the present invention.

FIG. 6 is a schematic configuration graph of the press of FIG. 3A.

FIG. 7 shows example structure parameters for simulation study, in millimeters.

FIG. 8 shows example optimization results for two example cases, in millimeters.

### DETAILED DESCRIPTION OF SPECIFIC EMBODIMENTS

The description above and below and the drawings of the present document refer to examples of embodiment(s) of the present invention and also describe some exemplary optional feature(s) and/or alternative embodiment(s). It will be understood that the embodiments referred to are for the purpose of illustration and are not intended to limit the invention specifically to those embodiments. For example, although embodiments of the present invention are discussed using examples involving particular numbers of linkages, the invention is not to be limited to those embodiments or to any particular fixed number of linkages. Rather, the invention is intended to cover all that is included within the spirit and scope of the invention, including alternatives, variations, modifications, equivalents, and the like.

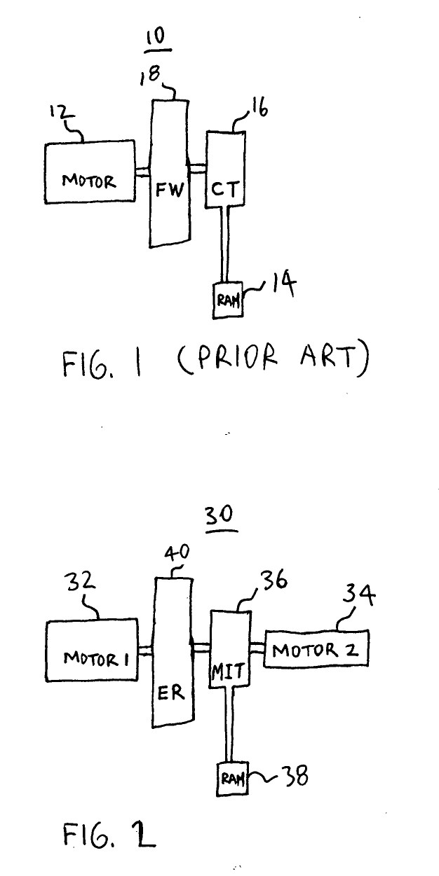

FIG. 1 is a schematic diagram of a conventional press 10, according to the prior art. The conventional press 10 includes a motor 12 that drives a ram 14 via a conventional transmission (CT) 16. The transmission optionally makes use of a flywheel (FW) 18 to help the press configuration handle high instantaneous power requirements and for energy efficiency. Typically, the motor 12 is an electric rotary motor, and the conventional transmission 16 converts rotary motion into a linear motion for driving the ram 14. Commonly, the motor 12 is a conventional common motor, and the flywheel 18 is relatively large. Optionally, if programmability of the conventional press 10 is desired, then the motor 12 may be a servo motor that is powerful enough to perform either without a flywheel 18 or to perform by overcoming (a relatively small) flywheel 18 when necessary.

Conventional stamping mechanisms are based on planar linkage mechanisms with one degree-of-freedom. Given a particular conventional stamping mechanism operating on a particular workpiece, the motion profile of the ram 14 (e.g., the position and/or speed as a function of time) for a stamping operation can be controlled only by controlling the output of the driving motor 12. Conceptually, the motion profile can be considered to be a fixed function of only one possibly-controllable parameter, namely, the output of the driving motor 12. It is known that the particular motion profile to be realized by a mechanical press can be fine-tuned ahead of time by appropriately designing an appropriate configuration of multiple linkages into the conventional transmission 16. Such tuning leads to more and more complicated configurations and higher and higher production and maintenance costs. Further, the lack of programmable flexibility still remains unless an extremely expensive powerful servomotor and a strong controller are used (and then only with a relatively small flywheel or no flywheel).

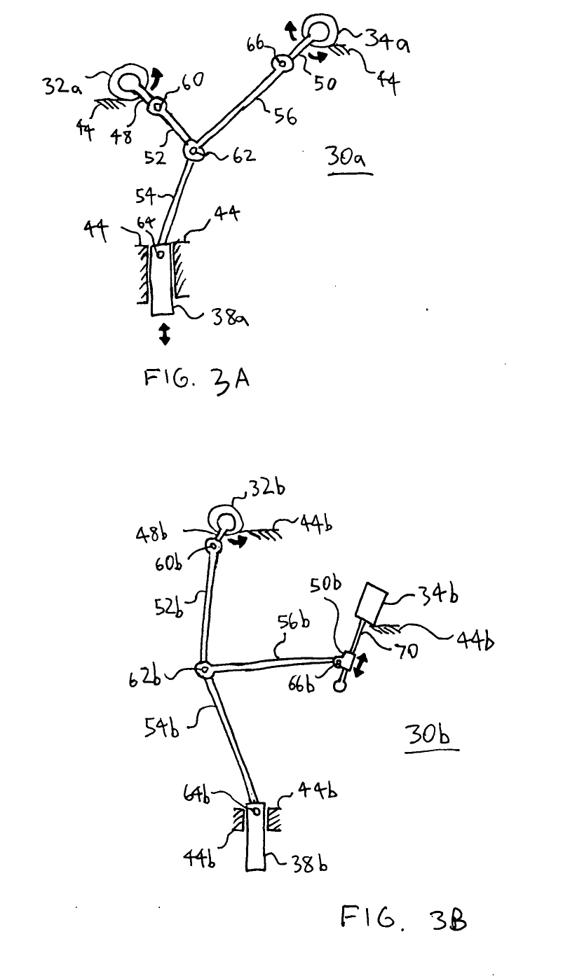

FIG. 2 is a schematic diagram of a new press 30, according to an embodiment of the present invention. The press 30 includes a first motor 32 and a second motor 34 that each provide mechanical movement that is accepted by a multiple-input transmission 36 (MIT) 36. As embodied according to FIG. 2, the multiple-input transmission 36 is a dual-input transmission 36. The dual-input transmission 36 responds to the mechanical movement from both the motors 32 and 34 in imparting movement to a ram 38. Optionally (and preferably), the dual-input transmission 36 makes use of an energy reservoir (ER) 40 (e.g., a flywheel) to help the press 30 handle high instantaneous power requirements and for energy efficiency. (The energy reservoir 40 is schematically shown as being between the multiple-input transmission 36 and the first motor 32, but in general, the energy reservoir can be located at any competent place within the drivetrain.)

Recall from discussion of FIG. 1 that, given a particular conventional stamping mechanism operating on a particular workpiece, the motion profile of a ram for a stamping operation can be controlled only by controlling the output of every motor (i.e., by controlling the output of the single motor). The new press 30 is different. In the new press 30, the motion profile of a ram for a stamping operation can be controlled by controlling the output of only one of the multiple motors.

For example, the first motor 32 may be embodied as a conventional common motor that has a fixed output (e.g., constant speed), and the multiple-input transmission 36 may be configured to respond to changes in the output of the second motor 34 by causing changes in the motion profile of the ram 38. In some embodiments of this example, the multi-input transmission 36 may be conceptually viewed as an otherwise conventional transmission that is primarily driven by the first motor 32. Accordingly, in this conceptual view, the multi-input transmission 36 realizes a function of the ram 38's motion profile as a function primarily of the output of the first motor 32. However, the multi-input transmission 36 is NOT actually conventional because its geometry can be dynamically changed by the second motor 34. Thus, even if the first motor 32 has fixed output, because the geometry of the transmission that the first motor 32 “sees” can be changed, therefore the motion profile (including position and speed and acceleration) of the ram 38 can be controlled by controlling the output the second motor 34. Such a configuration is efficient because the first motor 32 can efficiently run at constant speed, using an efficiently large flywheel, while the second motor 34 can be weaker (even much weaker) than the first motor 32 and does not have to fight the full momentum of the flywheel.

For example, the first motor 32 may be a large high-power common motor that provides a majority of the punching energy, and the second motor 34 may be a much smaller servomotor that can dynamically and programmatically fine-tune the motion profile of the ram 38. By re-programming the motion of the servomotor (34), the ram motion can be modified to have a desired performance or for desired stamping operations. In one embodiment, the common motor (32) is high powered and is expected to contribute a large part of the total energy dissipation, and the servomotor is low powered and is expected to be allocated a slim part of the total energy dissipation, according to the particular design chosen by the system designer.

FIG. 3A is a schematic diagram of a press 30a that is an embodiment of the press 30 of FIG. 2. As is shown, the press 30a includes a first motor 32a and a second motor 34a. The first motor 32a is preferably a cheap, powerful motor, for example, a constant-speed motor. The second motor 34a is preferably a variable-speed servomotor. A transmission that accepts output of the first motor 32a and the second motor 34a drives a ram 38a. A frame 44 includes a guidance track that guides the ram 38a and mounting points for the motors 32a and 34a. The transmission in this particular embodiment is a planar parallel mechanism in the form of a multi-bar mechanism. The transmission includes linkages (e.g., bars) 48, 50, 52, 54 and 56. The linkages are joined at rotary joints 60, 62, 64 and 66. The linkages 48 and 50 are cranks that are fixedly attached to the rotating shaft of the motors 32a and 34a.

The press 30a, minus the second motor 34a, its crank 50, the linkage 56 and the rotary joint 66, can be considered to be similar to a conventional press configuration with a simple, fixed drivetrain geometry. The second motor 34a, its crank 50, the linkage 56 and the rotary joint 66 effectively make the drivetrain of the press 30a have a programmably and dynamically variable geometry. With such a configuration, a great variety of motion profiles of the ram 38a can be obtained even if the first motor 32a merely turns at constant speed. During a single punch, while the first motor 32a turns the crank 48 at constant speed, the second motor 34a can turn its crank in arbitrary or jerky manner according to a program of operation, in order to produce the desired motion profile at the ram 38a. The second motor 34a can change the the geometry of the transmission that the first motor 32a “sees”, and the second motor 34a can sometimes also contribute some driving power to the ram 38a, according to its program. The transmission can be, and preferably is, configured such that the linkages are properly dimensioned according to geometric principles to permit the motors 32a and 34a to move freely. (Note that, for ease of viewing, FIG. 3A itself is not drawn to scale, and thus its linkages may not be “properly dimensioned”.)

FIG. 3B is a schematic diagram of an embodiment 30b of the press 30 of FIG. 2. The press 30b is a simple variation of the press 30a of FIG. 3A, and is substantially self-explanatory. The press 30b includes a first motor 32b and a second motor 34b. The first motor 32b is preferably a cheap, powerful motor, for example, a constant-speed motor. The second motor 34b is preferably a variable-speed servomotor. A transmission that accepts output of the first motor 32b and the second motor 34b drives a ram 38b. A frame 44b includes a guidance track that guides the ram 38b and mounting points for the motors 32b and 34b. The transmission in this particular embodiment is a planar parallel mechanism. The transmission includes linkages (e.g., bars) 48b, 50b, 52b, 54b and 56b. The linkages are joined at rotary joints 60b, 62b, 64b and 66b. The linkage 48 is a crank that is fixedly attached to the rotating shaft of the motors 32b. The linkage 50b is the ball portion of a ball and screw drive. A screw 70 is the shaft of the second motor 34b. The second motor 34b and a portion (elements 70, 50b, 56b, 66b and 62b) of the transmission can change the geometry of the transmission that the first motor 32b “sees”, and the second motor 34b can sometimes also contribute some driving power to the ram 38b, according to its program. As can be seen, the press 30b differs from the press 30a of FIG. 3A in using a ball and screw linkage instead of a crank linkage. In general, as should already be clear (see, e.g., FIG. 2), any competent type of actuator or other motor or linkage can also be used.

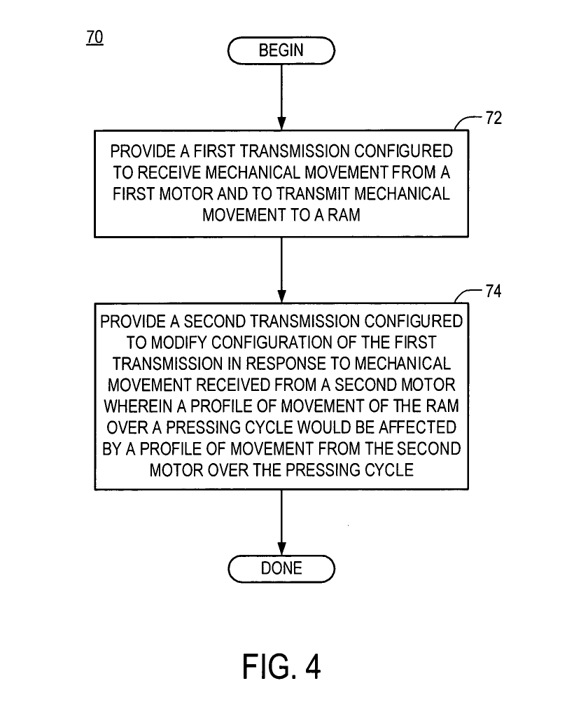

FIG. 4 is a schematic flow chart that illustrates a method 70 for providing at least a portion of a press according to an embodiment of the present invention. A step 72 includes providing a first transmission configured to receive mechanical movement from a first motor and to transmit mechanical movement to a ram. A step 74 includes providing a second transmission configured to modify configuration of the first transmission in response to mechanical movement received from a second motor wherein a profile of movement of the ram over a pressing cycle would be affected by a profile of movement from the second motor over the pressing cycle. By the steps 72 and 74, at least much of a transmission for a press is provided. Further portions of a press may be provided. For example, there could be a step of providing a ram, providing the first motor, providing the second motor, providing a frame, and the like. In one embodiment of the method 70, the step 74 provides the crank 50, the linkage 56 and the rotary joint 66 of FIG. 3A, and the step 72 provides at least some portions of the remainder of the transmission of FIG. 3A. Still other embodiments exist, according to other description from the present document.

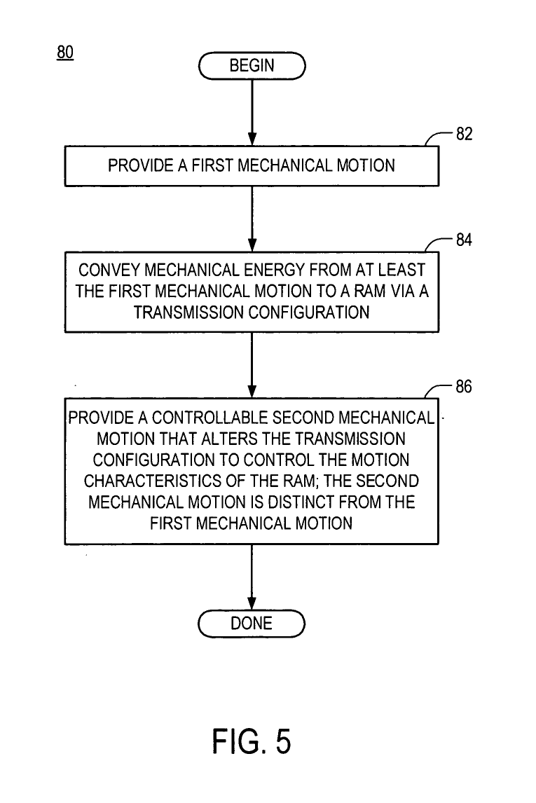

FIG. 5 is a schematic flow chart that illustrates a method 80 for stamping a workpiece according to an embodiment of the present invention. A step 82 includes providing a first mechanical motion. A step 83 includes conveying mechanical energy from at least the first mechanical motion to a ram via a transmission configuration. A step 84 includes providing a controllable second mechanical motion that alters the transmission configuration to control the motion characteristics of the ram, the second mechanical motion being distinct from the first mechanical motion. Further steps and variations can be used, based on other description in the present document.

Example Details

In the remainder of the present document, discussion and analysis will primarily be of the embodiment of the present invention that is shown in FIG. 3A. Other embodiments can be analyzed in a similar manner. In the remainder of the present document, references made to “the new press” or “the new machine” or the like refer to specific embodiment(s) and, as is true elsewhere in the present document, are not meant to limit the invention as a whole.

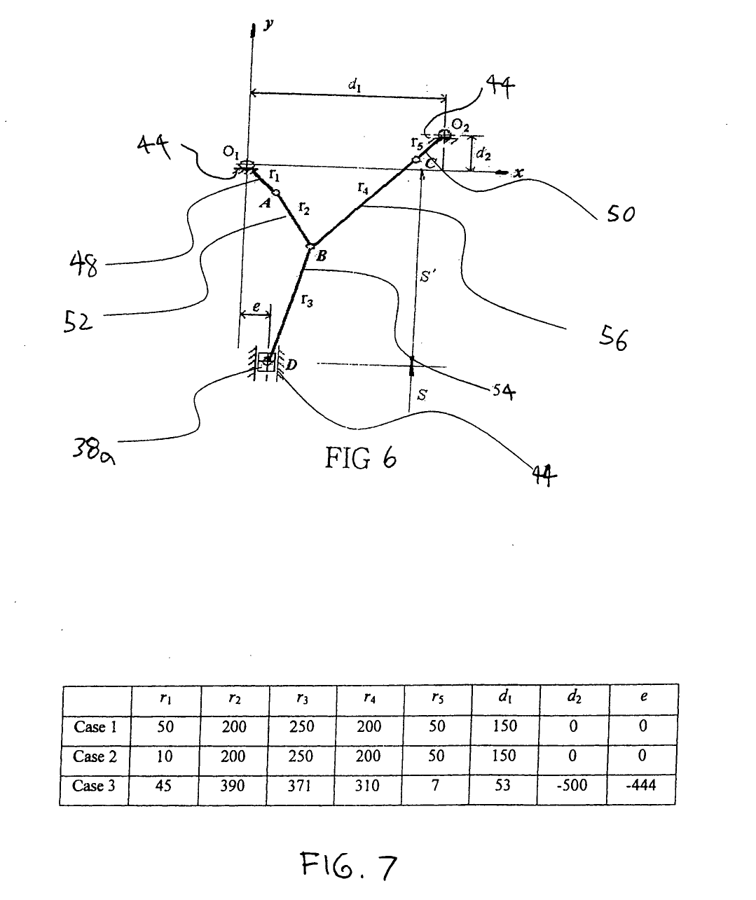

FIG. 6 is a schematic configuration graph of the press configuration of FIG. 3A. The frame 44, cranks 48 and 50, as well as links 52, 54 and 56 are parts of an embodiment of the multi-input transmission 36 of FIG. 2. The new press configuration shown in FIG. 6 is essentially a seven-bar mechanism (bars 48, 52, 50, 56, 54, the ram 38a, and the anvil of the machine formed by the frame 44) with two driving motors. The motor connected to the crank 48 is a constant-speed motor (CSM), which provides a majority of the energy. The other motor driving the crank 50 is a variable speed servomotor (VSM), which tunes the performance of the machine. Each motor drives a crank, which in turn drives the slide, or the ram. As shown in FIG. 6, this design has a total of eight dimensional parameters, r₁, r₂, r₃, r₄, r₅, d₁, d₂, and e, where the first five parameters are structure lengths and the last three are assembly parameters depending on the position and posture. In order to facilitate the modeling, a coordinate system is set up following the right-hand rule with its origin placed on the center of the CSM.

The working principle of the new machine is rather straightforward: taking away the controllable part of the mechanism (i.e., Bars 50 and 56), the machine is simply a five-bar slide-crank mechanism. The controllable part can be considered as an add-on component that fine-tunes the motion of the ram (including its displacement and velocity).

Feasibility Conditions

It is preferable to have the new machine move freely. To achieve this, a couple of feasibility conditions are used. These include the assembly condition and the double crank condition. Following the feasibility conditions, the reachable range of the ram can be derived. For convenience, the feasibility conditions are provided for the embodiment of FIG. 3A. Similar analysis can be performed in similar manner for the embodiment of FIG. 3B.

The assembly condition is as follows. From a mechanism point of view, as shown in FIG. 6, the new machine can be divided into two parts: the first part consists of five-bars: 48, 52, 50, 56 and 44. The second part is made of bar 54, the ram (the slide), and the ram guidance track, which is referred to as an Assur's RRP group of zero-degree-of-freedom. The first part must satisfy the following condition:
2max(r₁,r₂,r₄,r₅, d)<r₁+r₂+r₄+r₅+d (1)
where, d=\sqrt{d₁²+d₂²} is the distance between O₁ and O₂. On the other hand, the second part should be able to connect the first part at the Joint B without interference. This converts to the assembly constraint expressed below:
r₃≧max(dist) (2)
where, dist is the distance between Joint B and the central line of the ram guidance track.

The double-crank condition is as follows. In order for the machine to move freely, both bars 48 and 50 must be cranks. The double-crank condition consists of two parts. The first part can be expressed as:
|r₂−r₄|<r₁+r₅+d<r₂+r₄ (3.a)

The second part takes one of the following:
|r₂−r₄|<r₁−r₅−d<r₂+r₄
|r₂−r₄|<r₅+d−r₁<r₂+r₄
|r₂−r₄|<d−r₁−r₅<r₂+r₄
|r₂−r₄|<r₁+r₅−d<r₂+r₄
|r₂−r₄|<r₅−r₁−d<r₂+r₄
|r₂−r₄|<r₁+d−r₅<r₂+r₄ (3.b)
When the double crank condition is satisfied, the motions of the two cranks are unconstrained. In other words, one can rotate freely regardless where the other one goes, and vice versa.

Under the aforementioned conditions, the reachable range of the ram can be found. Note that the ram moves along the guidance track and the reachable range of the ram will be the controllable length of the ram's stroke. As shown in FIG. 6, this reachable range is decided by Point B, which is the joint between the RRR group of bars 48 and 52 as well as the RRR group of bars 50 and 56. Each group can be considered as an open chained binary-bar linkage. Thus, the feasible area of Joint B is the area in which the two groups intersect. The feasible regions of the two groups are rings described by radii |r₁−r₂| and (r₁+r₂), as well as |r₄−r₅| and (r₄+r₅) respectively. The intersection of the two rings includes two regions. In practice, Joint B can be in one of the two regions. For stamping presses, it is desirable that both groups are driven down when the ram presses the workpiece. Therefore, the desirable feasible region of Joint B is the region that can best satisfy this property.

Kinematical Model

To derive the kinematical model of the machine, the Assur's Group method is used. Its basic idea is divide-and-conquer. First, the machine is divided into four groups: Group 1 consists of the anvil of the machine and Link O₁A, Group 2 consists of the anvil of the machine and Link O₂C, Group 3 is made of Link AB and Link CB, and Group 4 is made of Link BD and the punch. Next, the kinematical model for each group is derived. Finally, by combining them all together, the kinematical model of the machine is found.

(a) Group 1: From FIG. 4, it is seen that the position of the hinge point A is:

$$\{ \begin{matrix}{x}_{1} = {r}_{1} cos {θ}_{1} \\ {y}_{1} = {r}_{1} sin {θ}_{1}\end{matrix} \qquad ( 4 )$$

where, θ₁ is the angular position of the CSM. By differentiation, the velocity can be found as follows:

$$\{ \begin{matrix}{\dot{x}}_{1} = - {r}_{1} sin {θ}_{1} \cdot {\dot{θ}}_{1} \\ {\dot{y}}_{1} = {r}_{1} cos {θ}_{1} \cdot {\dot{θ}}_{1}\end{matrix} \qquad ( 5 )$$

where, \dot{θ}₁ is the velocity of the CSM and it is constant. Hence, the acceleration is:

$$\{ \begin{matrix}{\ddot{x}}_{1} = 0 \\ {\ddot{y}}_{1} = 0\end{matrix} \qquad ( 6 )$$

(b) Group 2: Similar to Group 1, the position, velocity and acceleration of the hinge point C are as follows:

$$\begin{matrix}\{ \begin{matrix}{x}_{2} = {d}_{1} + {r}_{5} cos {θ}_{2} \\ {y}_{2} = {d}_{2} + {r}_{5} sin {θ}_{2}\end{matrix} & ( 7 ) \\ \{ \begin{matrix}{\dot{x}}_{2} = - {r}_{5} sin {θ}_{2} \cdot {\dot{θ}}_{2} \\ {\dot{y}}_{2} = {r}_{5} cos {θ}_{2} \cdot {\dot{θ}}_{2}\end{matrix} & ( 8 ) \\ \{ \begin{matrix}{\ddot{x}}_{2} = - {r}_{5} cos {θ}_{2} \cdot {\dot{θ}}_{2}^{2} - {r}_{5} sin {θ}_{2} \cdot {\ddot{θ}}_{2} \\ {\ddot{y}}_{2} = - {r}_{5} sin {θ}_{2} \cdot {\dot{θ}}_{2}^{2} + {r}_{5} cos {θ}_{2} \cdot {\ddot{θ}}_{2}\end{matrix} & ( 9 )\end{matrix}$$

where, θ₂, \dot{θ}₂, \ddot{θ}₂ are respectively the angular position, velocity and acceleration of the VSM.

(b) Group 3: The hinge point B is the critical point of the machine. From FIG. 4, it is seen that the position of B is determined by:

$$\{ \begin{matrix}{x}_{B} = {x}_{1} + {r}_{2} cos {φ}_{1} \\ {y}_{B} = {y}_{1} + {r}_{2} sin {φ}_{1}\end{matrix} \qquad ( 10 )$$

where, φ₁ is the angle between the link AB and the positive x axis and it is defined below:

$${φ}_{1} = 2 {tan}^{- 1} \frac{K \pm \sqrt{{K}^{2} + {L}^{2} - {M}^{2}}}{L + M}$$

where, K=2r₂(y₂−y₁), L=2r₂(x₂−xᵢ), and M=r₂²+(x₂−x₁)₂+(y₂−y₁)²−r₄². By means of derivative, the velocity can be found as follows:

$$\begin{matrix}\{ \begin{matrix}{\dot{x}}_{B} = {\dot{x}}_{1} - {r}_{2} sin {φ}_{1} \cdot {\dot{φ}}_{1} \\ {\dot{y}}_{B} = {\dot{y}}_{1} + {r}_{2} cos {φ}_{1} \cdot {\dot{φ}}_{1}\end{matrix} & ( 11 ) \\ where , {\dot{φ}}_{1} = - \frac{( {\dot{x}}_{2} - {\dot{x}}_{1} ) \cdot {r}_{4} cos {φ}_{2} + ( {\dot{y}}_{2} - {\dot{y}}_{1} ) \cdot {r}_{4} sin {φ}_{2}}{{r}_{2} sin {φ}_{1} \cdot {r}_{4} cos {φ}_{2} - {r}_{2} cos {φ}_{1} \cdot {r}_{4} sin {φ}_{2}} . & \end{matrix}$$

Here, φ₂ is the angle between Link CB and the positive x axis as defined below:

$${φ}_{2} = {tan}^{- 1} \frac{{y}_{2} - {y}_{1}}{{x}_{2} - {x}_{1}}$$

Furthermore, the acceleration is:

$$\begin{matrix}\{ \begin{matrix}{\ddot{x}}_{B} = {\ddot{x}}_{1} - {r}_{2} cos {φ}_{1} \cdot {\dot{φ}}_{1}^{2} - {r}_{2} sin {φ}_{1} \cdot {\ddot{φ}}_{1} \\ {\ddot{y}}_{B} = {\ddot{y}}_{1} - {r}_{2} sin {φ}_{1} \cdot {\dot{φ}}_{1}^{2} + {r}_{2} cos {φ}_{1} \cdot {\ddot{φ}}_{1}\end{matrix} & ( 12 ) \\ where , {\ddot{φ}}_{1} = - \frac{{C}_{1} {r}_{4} cos {φ}_{2} + {C}_{2} {r}_{4} sin {φ}_{2}}{{r}_{2} sin {φ}_{1} \cdot {r}_{4} cos {φ}_{2} - {r}_{2} cos {φ}_{1} \cdot {r}_{4} sin {φ}_{2}} & \\ Here , & \\ {C}_{1} = {\ddot{x}}_{2} - {\ddot{x}}_{1} + {r}_{2} cos {φ}_{1} \cdot {\dot{φ}}_{1}^{2} - {r}_{4} cos {φ}_{2} \cdot {\dot{φ}}_{2}^{2} , & \\ {C}_{2} = {\ddot{y}}_{2} - {\ddot{y}}_{1} + {r}_{2} sin {φ}_{1} \cdot {\dot{φ}}_{1}^{2} - {r}_{4} sin {φ}_{2} \cdot {\dot{φ}}_{2}^{2} , & \\ with & \\ {\dot{φ}}_{2} = \frac{( {\dot{x}}_{2} - {\dot{x}}_{1} ) \cdot {r}_{2} cos {φ}_{1} + ( {\dot{y}}_{2} - {\dot{y}}_{1} ) \cdot {r}_{2} sin {φ}_{1}}{{r}_{2} sin {φ}_{1} \cdot {r}_{4} cos {φ}_{2} - {r}_{2} cos {φ}_{1} \cdot {r}_{4} sin {φ}_{2}} & \end{matrix}$$

(d) Group 4: This RRP group describes the motion of the punch (i.e., the ram). Following the configuration in FIG. 4, assuming that the punch reaches the BDC at s′ₘᵢₙ, then the punch position is determined by
s=s′−s′ₘᵢₙ (13)
where, s′ₘᵢₙ=min(s′), and s′=y_{B}−\sqrt{r₃²−(e−x_{B})²}. In addition, the velocity of the punch is:

$$\dot{s} = {\dot{s}}^{′} = {\dot{y}}_{B} + \frac{e - {x}_{B}}{{s}^{′} - {y}_{B}} {\dot{x}}_{B} \qquad ( 14 )$$

Finally, the acceleration of the punch is:

$$\ddot{s} = {\ddot{s}}^{′} = {\ddot{y}}_{B} + \frac{e - {x}_{B}}{{s}^{′} - {y}_{B}} {\ddot{x}}_{B} - \frac{{\dot{x}}_{B} ( {s}^{′} - {y}_{B} ) + ( e - {x}_{B} ) {( {\dot{s}}^{′} - {\dot{y}}_{B} )}^{2}}{{( {s}^{′} - {y}_{B} )}^{2}} {\dot{x}}_{B} \qquad ( 15 )$$

Equations (13)-(15) define the displacement, velocity and acceleration of the punch. They are dependent on the angular speeds of the CSM and the VSM.
Mechanical Advantage, Torque And Power

The new machine has two distinct advantages. First, it is flexible, which has been shown above. Second, it is energy efficient. This is achieved by distributing the majority of the energy to the CSM, which carries a flywheel to ease the large impulsive metal forming force. The VSM, on the other hand, controls the motion, velocity and acceleration of the press but takes only a small load. This can be appreciated by studying the mechanical advantage, torque distribution and power distribution.

(a) Mechanical Advantage with Respect to the CSM: According to the static mechanics, the mechanical advantage of the machine with respect to the CSM (i.e. the proportion of the force F of the machine over the moment M₁ of the CSM), can be derived as shown below:

$$\frac{F}{{M}_{1}} = \frac{sin ( π - {γ}_{1} )}{sin ( π - {γ}_{2} )} \cdot \frac{cos {γ}_{4}}{{r}_{1} sin ( π - {γ}_{3} )} \qquad ( 16 )$$

where, γ₁ is the angle between Link BC and Link BA, γ₂ is the angle between Link BD and Link BC, γ₃ is the angle between Link AB and Link AO₁, and γ₄ is the angle between Link DB and the guidance of the ram. Note that they are all known since the instantaneous positions of the links can be found as shown in Section 2.3.

(b) Mechanical Advantage with Respect to the VSM: The mechanical advantage with respect to the VSM is:

$$\frac{F}{{M}_{2}} = \frac{sin ( π - {γ}_{1} )}{sin ( π - {γ}_{5} )} \cdot \frac{cos {γ}_{4}}{{r}_{5} sin ( π - {γ}_{6} )} \qquad ( 17 )$$

where, γ₅ is the angle between the link BA and the link BD, γ₆ the one between the link CO₂ and Link CB counterclockwise. They are both known.

(c) Mechanical Advantage of Hybrid Press: Integrating the equations (16) and (17) listed above, we can get the mechanical advantage for the hybrid press represented as

$$\begin{matrix}\frac{F}{M} = \frac{F}{{M}_{1} + {M}_{2}} \\ = \frac{sin ( π - {γ}_{1} ) cos {γ}_{4}}{sin ( π - {γ}_{2} ) \cdot {r}_{1} sin ( π - {γ}_{3} ) + sin ( π - {γ}_{5} ) \cdot {r}_{5} sin ( π - {γ}_{6} )}\end{matrix} \qquad ( 18 )$$

From Equation (18), it is seen the mechanical advantage of the machine is a function of its structure parameters as well as the angular positions of the motors.

(d) Moment Distribution for CSM: Based on Equation (16), the moment requirement of the CSM can be found:

$${M}_{1} = \frac{sin ( π - {γ}_{2} )}{sin ( π - {γ}_{1} )} \cdot \frac{sin ( π - {γ}_{3} )}{cos {γ}_{4}} \cdot {Fr}_{1} \qquad ( 19 )$$

(e) Moment Distribution for VSM: From Equation (17), the moment requirement of the VSM is as follows:

$${M}_{2} = \frac{sin ( π - {γ}_{5} )}{sin ( π - {γ}_{1} )} \cdot \frac{sin ( π - {γ}_{6} )}{cos {γ}_{4}} \cdot {Fr}_{5} \qquad ( 20 )$$

Neglecting the influences of the friction, damping, et a.l, it is seen that the moments of both the CSM and VSM are functions of the workload, the structures, and the angular positions of the motors.

(f) Power Distribution for CSM: The power distributed to the CSM is represented as follows:

$${P}_{1} = {M}_{1} {\dot{θ}}_{1} = \frac{F}{cos {γ}_{4}} \cdot {r}_{1} \frac{sin ( π - {γ}_{2} )}{sin ( π - {γ}_{1} )} sin ( π - {γ}_{3} ) \cdot {\dot{θ}}_{1} \qquad ( 21 )$$

(g) Power Distribution for VSM: The power distributed to the VSM is expressed by

$$\begin{matrix}{P}_{2} = {M}_{2} {\dot{θ}}_{2} \\ = {M}_{2} \frac{ⅆ {θ}_{2}}{ⅆ {θ}_{1}} {\dot{θ}}_{1} \\ = \frac{F}{cos {γ}_{4}} \cdot {r}_{5} \frac{sin ( π - {γ}_{5} )}{sin ( π - {γ}_{1} )} sin ( π - {γ}_{6} ) \cdot \frac{ⅆ {θ}_{2}}{ⅆ {θ}_{1}} \cdot {\dot{θ}}_{1}\end{matrix} \qquad ( 22 )$$

(h) Discussion: Going through Equations (16)˜(20), it can be seen that the machine will lose payload capacity momentarily when γ₁=0, π (where Link 52 and Link 56 are in line), or γ₄=π/2 (where Link 54 is perpendicular to the guidance of the ram). This means no force could be generated despite of large moment given by both motors. Fortunately, these cases would not happen for the unconstrained double-crank press. On the other hand, it is interesting to see that the machine can produce a large payload without the CSM moment input when γ₂=0 or π (where, Link BD and Link CB are collinear), and/or γ₃=0, π (where Link 48 and Link 52 are in line). Similarly, it can do the same without the VSM moment input when γ₅=0, π (where Link 54 and Link 52 are collinear) and/or γ₆=0, π (where Link 50 and Link 56 are in line). Of course, these would not happen in practice because of the friction and damping.

In addition, according to Equations (19) to (22), the moment and the power required from the VSM and the CSM would be lower when γ₁ is near π/2 or 3π/2 (i.e., Link 56 is perpendicular to Link 52) and/or γ₄ is near 0 or π (i.e., Link 54 is parallel to the ram guidance). Besides, according to Equation (22), the power required from the VSM also depends on the ratio of the VSM's angular speed and the CSM's angular speed (i.e., dθ₂/dθ₁). This involves the trajectory planning, which will be discussed further below.

In summary, to improve the energy efficiency, following conditions should be kept: (1) Link 54 and Link 52 are nearly collinear, (2) Link 56 and Link 52 are almost orthogonal, and (3) Link 54 is closely collinear with the ram.

Computer Simulations

Based on the model presented above, and on models that can similarly be adopted for other particular embodiments or geometries, computer simulations can be carried out to demonstrate that the performance of the new machine can be programmed. As an example, simulations were run for three example cases (“Case 1”, “Case 2”, and “Case 3”). FIG. 7 shows structure parameters for these example cases, in millimeters. From running simulations, it can seen that, for some geometries, e.g., the geometry shown in FIG. 3A, small dimension variation can result in significantly different performance. For example, for Case 1, the moment required from the VSM is nearly the same as that of the CSM. For Case 2, it is almost ten times bigger than that of the CSM. And for Case 3, it is nearly ten times smaller than that of the CSM.

Design Optimization

From the simulation results presented in the previous section, it is seen that the structure parameters have a significant influence on the performance of the machine. Computer optimization of the structure parameters can be performed using any suitable optimization technique, according to the particular needs and goals of the system designer.

An Example Optimization Model

The optimization parameters can be denoted as a vector:
X=(r₁,r₂,r₃, r₄,r₅,d₁,d₂,e) (23)
The objective function is defined as follows:
F=\overline{ω}₁ max(M₁)+\overline{ω}₂ max(M₂)+\overline{ω}₃(1/Φ)+\overline{ω}₄(1/min(SA)) (24)
where, \overline{ω}₁, \overline{ω}₂, \overline{ω}₃, and \overline{ω}₄ are weighting factors. Note that the weighting factors have physical meanings. For example, it is desirable to have \overline{ω}₁<<\overline{ω}₂ (i.e., the moment of the CSM shall be much bigger than that of the VSM). Also, Φ is the maximal rotational angle of the CSM when the ram is close to the BDC (see FIG. 13). This term favors the long dwelling time. Finally, SA is the range of the ram, which describes the adjustability of the stroke (see FIG. 13). In FIG. 13, the top curve represents the highest possible position of the ram, and the bottom curve represents the lowest position of the ram. The optimization constraints include the assembly conditions and the double crank condition given above.

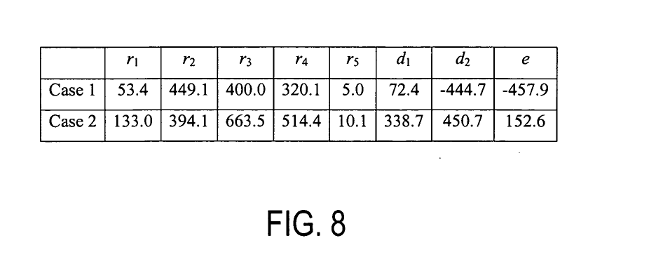

The Genetic Algorithm (GA) may be used for optimization. Example optimizations were carried out under two different goals. The first one is to minimize the moments of the CSM and the VSM without considering the dwelling angle (i.e., \overline{ω}₃=0) and the ram travel range (i.e., \overline{ω}₄=0). The second one is to minimize the moments of the motors and the dwelling angle as well as the ram travel range. FIG. 8 shows the optimization results for two example cases, in millimeters. From studying the optimization results, it can be observed that the ram travel range in Case 2 is much larger than that of Case 1. On the other hand, it is seen the driving moment required from the VSM in Case 1 is far less than that of Case 2. Hence, in the machine design, it is necessary to balance different factors, which can be done by adjusting the weighting factors in Equation (24), according to the particular goals of the system designer for the particular envisioned application.

Discussion

It is seen that the new machine can be easily and dynamically adjusted to form different strokes (i.e., different motion profiles) without reassembly of the machine. In other words, it can behave like a hydraulic press or a servomotor driven press, though it is much cheaper to make. Compared with the hydraulic presses or servomotor driven presses, the new machine is very efficient in terms of energy usage. One reason is that it can use a large constant speed motor with a large flywheel to produce majority of the force, and at the same time use a small servomotor to tune the performance. The design can be optimized to provide performance balancing the kinematical flexibility and the energy consumption.

The Inverse Kinematics Model

In practice, user may want to specify a desirable trajectory (or at least several crucial points on the trajectory). The inverse kinematics is needed to determine the corresponding angular motions of the two motors based on the desirable trajectory. This kinematics problem can be solved in the fashion of the robot inverse kinematics problem: given a trajectory in the workspace, determine the motions of the joints in the joint space.

For our new machine, the joint space parameters include (a) the angular parameters of the CSM including θ₁₀ (initial angular position), θ₁ (angular displacement), \dot{θ}₁ (angular speed) and \ddot{θ}₁ (angular acceleration); (b) the angular parameters of the VSM including θ₂₀ (initial angular position), θ₂ (angular displacement), \dot{θ}₂ (angular speed) and \ddot{θ}₂ (angular acceleration). On the other hand, the work space parameters include s (ram travel), \dot{s} (ram speed) and \ddot{s} (ram acceleration). The inverse kinematics model can be derived based on the kinematics model. As shown above, the kinematics of the model can be described by the vector equations below:

$$\{ \begin{matrix}{r}_{1} + {r}_{2} + {r}_{3} = e + {s}^{′} \\ {r}_{1} + {r}_{2} = d + {r}_{5} + {r}_{4}\end{matrix} \qquad ( B1 )$$

where, d=d₁+d₂. Equation (B1) can be decomposed into a set of scale equations as follows

$$\{ \begin{matrix}{r}_{1} cos ( {θ}_{1} + {θ}_{10} ) + {r}_{2} cos {β}_{1} + {r}_{3} cos {β}_{3} = e \\ {r}_{1} sin ( {θ}_{1} + {θ}_{10} ) + {r}_{2} sin {β}_{1} + {r}_{3} sin {β}_{3} = {s}^{′} \\ {r}_{1} cos ( {θ}_{1} + {θ}_{10} ) + {r}_{2} cos {β}_{1} = {d}_{1} + {r}_{5} cos ( {θ}_{2} + {θ}_{20} ) + {r}_{4} cos {β}_{2} \\ {r}_{1} sin ( {θ}_{1} + {θ}_{10} ) + {r}_{2} sin {β}_{1} = {d}_{2} + {r}_{5} sin ( {θ}_{2} + {θ}_{20} ) + {r}_{4} sin {β}_{2}\end{matrix} \qquad ( B2 )$$

where, β₁ is the angle between Link AB and positive x axis, β₂ is the angle between Link CB and positive x axis, and β₃ is the angle between Link BD and positive x axis, all in counterclockwise. In addition, s′=(s+s′ₘᵢₙ), where s′ₘᵢₙ=min(s′). From Equation (B2), the inverse angular positions can be derived as follows:

$$\begin{matrix}{β}_{1} = 2 {tan}^{- 1} \frac{{B}_{1} \pm \sqrt{{B}_{1}^{2} + {A}_{1}^{2} - {C}_{1}^{2}}}{{C}_{1} + {A}_{1}} & ( B3 ) \\ {β}_{3} = 2 {tan}^{- 1} \frac{{B}_{1} \pm \sqrt{{B}_{1}^{2} + {A}_{1}^{2} - {C}_{2}^{2}}}{{C}_{2} + {A}_{1}} & ( B4 ) \\ {θ}_{2} = 2 {tan}^{- 1} \frac{{B}_{2} \pm \sqrt{{B}_{2}^{2} + {A}_{2}^{2} - {D}_{1}^{2}}}{{D}_{1} + {A}_{2}} - {θ}_{20} & ( B5 ) \\ {β}_{2} = 2 {tan}^{- 1} \frac{{B}_{2} \pm \sqrt{{B}_{2}^{2} + {A}_{2}^{2} - {D}_{2}^{2}} }{{D}_{2} + {A}_{2}} \\ where , \\ \begin{matrix}{A}_{1} = e - {r}_{1} cos ( {θ}_{1} + {θ}_{10} ) \\ {A}_{2} = {r}_{1} cos ( {θ}_{1} + {θ}_{10} ) + {r}_{2} cos {β}_{1} - {d}_{1} \\ {B}_{1} = {s}^{′} - {r}_{1} sin ( {θ}_{1} + {θ}_{10} ) = s + {s}_{min}^{′} - {r}_{1} sin ( {θ}_{1} + {θ}_{10} ) \\ {B}_{2} = {r}_{1} sin ( {θ}_{1} + {θ}_{10} ) + {r}_{2} sin {β}_{1} - {d}_{2} \\ {C}_{1} = \frac{{A}_{1}^{2} + {B}_{1}^{2} + {r}_{2}^{2} - {r}_{3}^{2}}{2 {r}_{2}} \\ {C}_{2} = \frac{{A}_{1}^{2} + {B}_{1}^{2} + {r}_{3}^{2} - {r}_{2}^{2}}{2 {r}_{3}} \\ {D}_{1} = \frac{{A}_{2}^{2} + {B}_{2}^{2} + {r}_{5}^{2} - {r}_{4}^{2}}{2 {r}_{5}} \\ {D}_{2} = \frac{{A}_{2}^{2} + {B}_{2}^{2} + {r}_{4}^{2} - {r}_{5}^{2}}{2 {r}_{4}}\end{matrix} & ( B6 )\end{matrix}$$

Note that the solution is not unique.

Differentiating Equation (B2) with respect to time, t, and then using Cramer Rule, the inverse angular velocities can be found as follows

$$\begin{matrix}{\dot{β}}_{1} = \frac{\vert \begin{matrix}- {\dot{A}}_{1} & {r}_{3} sin {β}_{3} \\ {\dot{B}}_{1} & {r}_{3} cos {β}_{3}\end{matrix} \vert}{\vert \begin{matrix}{r}_{2} sin {β}_{1} & {r}_{3} sin {β}_{3} \\ {r}_{2} cos {β}_{1} & {r}_{3} cos {β}_{3}\end{matrix} \vert} & ( B7 ) \\ {\dot{β}}_{3} = \frac{\vert \begin{matrix}{r}_{2} sin {β}_{1} & - {\dot{A}}_{1} \\ {r}_{2} cos {β}_{1} & {\dot{B}}_{1}\end{matrix} \vert}{\vert \begin{matrix}{r}_{2} sin {β}_{1} & {r}_{3} sin {β}_{3} \\ {r}_{2} cos {β}_{1} & {r}_{3} cos {β}_{3}\end{matrix} \vert} & ( B8 ) \\ {\dot{θ}}_{2} = \frac{\vert \begin{matrix}- \dot{{A}_{2}} & {r}_{4} sin {β}_{2} \\ {\dot{B}}_{2} & {r}_{4} cos {β}_{2}\end{matrix} \vert}{\vert \begin{matrix}{r}_{5} sin ( {θ}_{2} + {θ}_{20} ) & {r}_{4} sin {β}_{2} \\ {r}_{5} cos ( {θ}_{2} + {θ}_{20} ) & {r}_{4} cos {β}_{2}\end{matrix} \vert} & ( B9 ) \\ {\dot{β}}_{2} = \frac{\vert \begin{matrix}{r}_{5} sin ( {θ}_{2} + {θ}_{20} ) & - {\dot{A}}_{2} \\ {r}_{5} cos ( {θ}_{2} + {θ}_{20} ) & {\dot{B}}_{2}\end{matrix} \vert}{\vert \begin{matrix}\begin{matrix}{r}_{5} sin ( {θ}_{2} + {θ}_{20} ) \\ {r}_{5} cos ( {θ}_{2} + {θ}_{20} )\end{matrix} & \begin{matrix}{r}_{3} sin {β}_{2} \\ {r}_{3} cos {β}_{2}\end{matrix}\end{matrix} \vert} \\ where , \\ \begin{matrix}{\dot{A}}_{1} = {r}_{1} sin ( {θ}_{1} + {θ}_{10} ) \cdot {\dot{θ}}_{1} \\ {\dot{A}}_{2} = {r}_{1} sin ( {θ}_{1} + {θ}_{10} ) \cdot {\dot{θ}}_{1} - {r}_{2} sin {β}_{1} \cdot {\dot{β}}_{1} \\ \begin{matrix}{\dot{B}}_{1} = \dot{s} - {r}_{1} cos ( {θ}_{1} + {θ}_{10} ) \cdot {\dot{θ}}_{1} \\ {\dot{B}}_{2} = {r}_{1} cos ( {θ}_{1} + {θ}_{10} ) \cdot {\dot{θ}}_{1} + {r}_{2} cos {β}_{1} \cdot {\dot{β}}_{1}\end{matrix}\end{matrix} & ( B10 )\end{matrix}$$

Furthermore, double differentiating Equation (B2) and using Cramer Rule again, the inverse angular accelerations can be found as follows

$$\begin{matrix}{\ddot{β}}_{1} = \frac{\vert \begin{matrix}\begin{matrix}{L}_{1} \\ {L}_{2}\end{matrix} & \begin{matrix}{r}_{3} sin {β}_{3} \\ {r}_{3} cos {β}_{3}\end{matrix}\end{matrix} \vert}{\vert \begin{matrix}\begin{matrix}{r}_{2} sin {β}_{1} \\ {r}_{2} cos {β}_{1}\end{matrix} & \begin{matrix}{r}_{3} sin {β}_{3} \\ {r}_{3} cos {β}_{3}\end{matrix}\end{matrix} \vert} & ( B11 ) \\ {\ddot{β}}_{3} = \frac{\vert \begin{matrix}{r}_{2} sin {β}_{1} & {L}_{1} \\ {r}_{2} cos {β}_{1} & {L}_{2}\end{matrix} \vert}{\vert \begin{matrix}{r}_{2} sin {β}_{1} & {r}_{3} sin {β}_{3} \\ {r}_{2} cos {β}_{1} & {r}_{3} cos {β}_{3}\end{matrix} \vert} & ( B12 ) \\ {\ddot{θ}}_{2} = \frac{\vert \begin{matrix}\begin{matrix}{R}_{1} \\ {R}_{2}\end{matrix} & \begin{matrix}{r}_{4} sin {β}_{2} \\ {r}_{4} cos {β}_{2}\end{matrix}\end{matrix} \vert}{\vert \begin{matrix}\begin{matrix}{r}_{5} sin ( {θ}_{2} + {θ}_{20} ) \\ {r}_{5} cos ( {θ}_{2} + {θ}_{20} )\end{matrix} & \begin{matrix}{r}_{4} sin {β}_{2} \\ {r}_{4} cos {β}_{2}\end{matrix}\end{matrix} \vert} & ( B13 ) \\ {\ddot{β}}_{2} = \frac{\vert \begin{matrix}\begin{matrix}{r}_{5} sin ( {θ}_{2} + {θ}_{20} ) \\ {r}_{5} cos ( {θ}_{2} + {θ}_{20} )\end{matrix} & \begin{matrix}{R}_{1} \\ {R}_{2}\end{matrix}\end{matrix} \vert}{\vert \begin{matrix}{r}_{5} sin ( {θ}_{2} + {θ}_{20} ) & {r}_{3} sin {β}_{2} \\ {r}_{5} cos ( {θ}_{2} + {θ}_{20} ) & {r}_{3} cos {β}_{2}\end{matrix} \vert} \\ where , \\ \begin{matrix}{L}_{1} = - {\ddot{A}}_{1} - {r}_{2} cos {β}_{1} \cdot {\dot{β}}_{1}^{2} - {r}^{3} cos {β}_{3} \cdot {\dot{β}}_{3}^{2} \\ {L}_{2} = {\ddot{B}}_{1} + {r}_{2} sin {β}_{1} \cdot {\dot{β}}_{1}^{2} + {r}^{3} sin {β}_{3} \cdot {\dot{β}}_{3}^{2} \\ {R}_{1} = {\ddot{A}}_{2} - {r}_{5} cos ( {θ}_{2} + {θ}_{20} ) \cdot {\dot{θ}}_{2}^{2} - {r}_{4} cos {β}_{2} \cdot {\dot{β}}_{2}^{2} \\ {R}_{2} = {\ddot{B}}_{2} + {r}_{5} sin ( {θ}_{2} + {θ}_{20} ) \cdot {\dot{θ}}_{2}^{2} + {r}_{4} sin {β}_{2} \cdot {\dot{β}}_{2}^{2}\end{matrix} \\ Here , \\ \begin{matrix}{\ddot{A}}_{1} = {r}_{1} sin ( {θ}_{1} + {θ}_{10} ) \cdot {\ddot{θ}}_{1} + {r}_{1} cos ( {θ}_{1} + {θ}_{10} ) \cdot {\dot{θ}}_{1}^{2} \\ {\ddot{A}}_{2} = - {r}_{1} sin ( {θ}_{1} + {θ}_{10} ) \cdot {\ddot{θ}}_{1} - {r}_{2} sin {β}_{1} \cdot {\ddot{β}}_{1} - {r}_{1} cos ( {θ}_{1} + {θ}_{10} ) \cdot \\ {\dot{θ}}_{1}^{2} - {r}_{2} cos {β}_{1} \cdot {\dot{β}}_{1}^{2} \\ {\ddot{B}}_{1} = \ddot{s} - {r}_{1} cos ( {θ}_{1} + {θ}_{10} ) \cdot {\ddot{θ}}_{1} + {r}_{1} sin ( {θ}_{1} + {θ}_{10} ) \cdot {\dot{θ}}_{1}^{2} \\ {\dot{B}}_{2} = {r}_{1} cos ( {θ}_{1} + {θ}_{10} ) \cdot {\ddot{θ}}_{1} + {r}_{2} cos {β}_{1} \cdot {\ddot{β}}_{1} - {r}_{1} sin ( {θ}_{1} + {θ}_{10} ) \cdot \\ {\dot{θ}}_{1}^{2} - {r}_{2} sin {β}_{1} \cdot {\dot{β}}_{1}^{2}\end{matrix} & ( B14 )\end{matrix}$$

The Effect of the Initial Angular Positions of the Motors

Unlike the robot inverse kinematics problem, the initial positions of the two motors play an important role. As pointed out above, the CSM rotates continuously at a constant speed. And the speed of the VSM varies to accommodate the required trajectory needs. From a mechanical point of view, as shown in FIG. 6, the machine includes two cranks: Links 48 and 52 as well as Links 50 and 56. The ram travel is a periodic function with the two crank angles: θ₁=[0, 2π] and θ₂=[0, 2π]. Nevertheless, with different initial angular positions θ₁₀ and (θ₂₀, rather different travel may take place, as would be apparent from evaluating the equations using a variety combinations of θ₁₀ and θ₂₀ for various motor output profiles. It is desirable to synchronize the two motors in real time, as is described further below.

Trajectory Planning and Optimization

Any competent trajectory planning (and any optimization) technique can be used. The objective of trajectory planning is to determine the motion of the VSM such that the ram travel fulfills the user's requirements. In practice, the user usually gives a vague definition of the desirable travel, such as (a) smooth pressing to avoid large transient force and vibration, (b) long dwelling time to ensure complete metal deformation, and (c) slow releasing to minimize workpiece spring-back. These requirements can be represented by a number of critical points, also called via points. The trajectory is to pass through these via points. In practice, more via points and dwelling segments may be added.

One procedure for trajectory planning and optimization is as follows:

Step 1: Compute the corresponding points in the joint space with position, velocity and/or acceleration based on the inverse kinematics described above;

Step 2: Determine the trajectories segment by segment in the joint space by polynomial interpolation and optimization; and

Step 3: Combine the joint trajectory segments to form the entire trajectory.

Optimization

As shown in an earlier section above, the majority of the power is distributed to the CSM. Furthermore, the power consumption of the CSM is independent on the ratio of the VSM speed and the CSM speed. On the contrary, the power consumption of the VSM is changing with respect to that ratio and hence, could be minimized. In other words, it is possible to design a path to lower the energy consumption of the VSM. To do this, an optimization procedure is carried out. The goal of the optimization is to minimize the energy of the VSM as defined below:

$$F = {\int }_{0}^{T} \vert {P}_{2} \vert ⅆ t \\ where , \\ {P}_{2} = \frac{F}{cos {γ}_{4}} \cdot {r}_{5} \frac{sin ( π - {γ}_{5} )}{sin ( π - {γ}_{1} )} sin ( π - {γ}_{6} ) \cdot \frac{ⅆ {θ}_{2}}{ⅆ {θ}_{1}} \cdot {\dot{θ}}_{1} , \\ T = \frac{2 π}{{\dot{θ}}_{1}} \qquad ( B15 )$$

Note that γ₁ is the angle between Link BC and Link BA, γ₄ is the angle between Link DB and the anvil of the press, γ₅ is the angle between Link BA and Link BD, and γ₆ is the angle between Link CO₂ and Link CB, all defined in counterclockwise. For simplicity, Equation (B15) can be approximated by the discrete form below:

$$F = {\sum }_{i = 1}^{n + 1} {( \vert {P}_{2} \vert )}_{{t}_{i}} {Δt}_{i} \qquad ( B16 )$$

where, n is the number of discrete points along the path. This objective function can also be replaced by other criteria, such as the peak power of the VSM.

The trajectory optimization problem, such as the one above, is a highly nonlinear optimization problem. According to literature, it has been studied in a number of articles. The Genetic Algorithm (GA) may be used.

Sensitivity Analysis and Error Compensation

In practice, there may be many errors, such as dimension error, assembly error and motor/belt backlash, that may cause the deterioration of the machine performance. Based on mathematical models, the possible errors of the machine include the machine structure errors: Δr₁, Δr₂, Δr₃, Δr₄ and Δr₅ (corresponding to r₁, r₂, r₃, r₄ and r₅ respectively); the assembly errors Δd₁, Δd₂ and Δe (corresponding to d₁, d₂ and e respectively); as well as the motor motion errors Δθ₁ and Δθ₂ (corresponding to θ₁ and θ₂). These errors can affect the ram travel and can be compensated for.

Sensitivity Analysis

According to the tolerancing theory, the partial derivative of the travel with respect to a parameter can be used to evaluate the sensitivity of that parameter. Thus, the sensitivities of the aforementioned errors are as follows:
s′r_{ᵢ}=∂s/∂rᵢ, i=1˜5, (B17)
s′_{d}_{ᵢ}=∂s/∂dᵢ, i=1, 2, (B18)
s′ₑ=∂s/∂e′ (B19)
s′_{θ}_{ᵢ}=∂s/∂θᵢ, i=1, 2, (B20)
With tedious but straightforward calculus manipulation, the solutions of s′ᵣ_{ᵢ} (i=1˜5), s′_{d}_{ᵢ} (i=1, 2), s′ₑ as well as s′_{θ}_{ᵢ} (i=1, 2) can be found. By performing simulations, it can be discovered which parameters are the most sensitive, and hence, it can be known which dimensional tolerance and/or which assembly tolerance most especially should be minimized. For some embodiments of the invention, the most sensitive parameters of the design are r₁, r₅, d₁ and d₂. Hence, their tolerances especially should be minimized. In general, the error should be minimized when building and assembling the machine and/or be compensated for when the machine is running.

In general, the aforementioned errors can be grouped into two types: time-independent errors and time-dependent errors. The former includes the structural errors (Δr₁, Δr₂, Δr₃, Δr₄ and Δr₅) and assembly errors (d₁, d₂ and e). When the machine is made, these errors are fixed and hence, are time-independent. On the other hand, the motor rotation errors (Δθ₁ and Δθ₂) are dependent on the motion and hence, are time-dependent. Different methods may be used to compensate for these two types of errors.

Compensating the Time Independent Errors by Trajectory Planning

Without losing generality, let R₁, R₂, R₃, R₄ and R₅ as well as D₁, D₂ and E be the actual dimensions of the machine, then
Rᵢ=rᵢ+Δrᵢ, i=1˜5 (B21)
Dᵢ=dᵢ+Δdᵢ, i=1, 2 (B22)
E=e+Δe (B23)
Suppose that the errors can be measured (or equivalently, the actual dimension of the machine can be measured precisely), then it is possible to compensate them by means of trajectory planning. This is done by simply using the actual parameters, Rᵢ, i=1˜5, Dᵢ, i=1, 2, and E replacing the design parameters, rᵢ, i=1˜5, Dᵢ, i=1, 2, and e in trajectory planning and optimization. It is interesting to know that such a compensation cannot be done in conventional 1-DOF stamping press. This is another advantage of our new machine.
Compensating Motor Rotation Errors by Feedback Control

The time-dependent error Δθ₁ and Δθ₂ can be compensated by means of feedback control. In practice, the CSM rotates at a constant speed and hence, is uncontrollable. Nevertheless, through an encoder its error, Δθ₁, can be measured. On the other hand, the VSM is a servomotor and its rotation is measurable and controllable. Therefore, the speed of the VSM can be regulated to compensate for the time-dependent motor rotation error in real time.

### FURTHER DESCRIPTION OF EMBODIMENT(S)

Other embodiments of the present invention are apparatuses or articles produced according to any method embodiment of the present invention or produced by any apparatus embodiment of the present invention. For example, any metal or other article (e.g., automobile parts, appliance parts, container parts, and the like) produced by a method or apparatus embodiment of the present invention.)

An embodiment of the present invention relates to a programmable numerical control mechanical press, which best appeals to the trend of manufacturing philosophy shifting from rigid automation to flexible automation with low cost.

An embodiment of the present invention is directed to developing a new family of mechanical presses wherein it is desired to accommodate different stamping operations by re-programming without any disassembly.

An embodiment of the present invention provides a programmable punching mechanism for a mechanical press which includes the ability to vary the stroke and travel by re-programming without disassembly of the press.

An embodiment of the invention comprises a mechanical press containing a two degree-of-freedom planar parallel punching mechanism. One portion of the mechanism comprises a closed-chain planar five-bar linkage. The other portion of the mechanism comprises a zero degree-of-freedom slide-link group. The two portions form a seven-bar punching mechanism.

An embodiment of the invention comprises a mechanical press containing two different driving motors. One motor is an arbitrary kind of common motor, or un-adjustable constant speed motor with a large power, whose motion is un-controllable. The other one is an arbitrary kind of servomotor, or programmable variable speed motor with a low power, whose motion is controllable and programmable or numerical control. The two different motors synchronized drive said punching mechanism.

An embodiment of the invention also comprises an optimized dimensional design method using energy deployment and motion flexibility as key objective indexes. This new index ensures the configuration parameters reasonable in terms of energy deployment and motion flexibility.

An advantage of an embodiment the present invention is the ability to create a versatile use press that has a programmable drive mechanism which can be modified by numerical control with re-programming without disassembly such that press down time is effectively eliminated.

Another advantage of an embodiment of the present invention is that it has a travel space while traditional mechanical press has only a travel curve. This makes it possible that almost all categories of stamping operations can be completed on a same press.

Another advantage of an embodiment of the present invention is that operation and maintenance costs are low by comparison with programmable hydraulic press or current numerical control mechanical press for there are only little changes in the embodiment of the present invention from the current mechanical press in terms of configuration and drive. An embodiment of present invention is also energy efficient with the usage of flywheel.

A further advantage of an embodiment of the present invention is that manufacturing and assembly errors can be compensated by software with feedback control algorithm without physical adjustment and high accuracy maintains whatever wear happens.

Example embodiment EX-1. A programmable configuration for mechanical press, comprising: a 2 degree-of-freedom planar parallel punching mechanism; and a drive mode with two different motors.

Example embodiment EX-2. The programmable configuration as recited in example embodiment EX-1, further comprising: a corresponding optimized design method to determine said punching mechanism and said driving motors' size; and a track tracing of said servomotor following said common motor to keep synchronized of said two motors.

Example embodiment EX-3. The programmable configuration as recited in example embodiment EX-1, wherein said a 2 degree-of-freedom planar parallel punching mechanism, comprises: a closed five-bar planar parallel drive; and a slide-link group of zero degree-of-freedom.

Example embodiment EX-4. The programmable configuration as recited in example embodiment EX-1, wherein said a drive mode with two different motors comprises: one un-adjustable constant speed motor, namely common motor; and one programmable variable speed motor, namely servomotor or other electrical motor.

Example embodiment EX-5. The programmable configuration as recited in example embodiment EX-2, wherein said a corresponding optimized design method comprises a special objective function characterized with two important indexes: energy (whether moment, power or work) deployment between the two motors and ram motion flexibility including dwelling angle (or time) and adjustable travel range to induce the optimization process, which will lead to a large power requirement of said common motor as well as a low power requirement of said servomotor, and also to a travel space to make press have ability to program travel curves whatever are desired.

Throughout the description and drawings, example embodiments are given with reference to specific configurations. It will be appreciated by those of ordinary skill in the art that the present invention can be embodied in other specific forms. The scope of the present invention, for the purpose of the present patent document, is not limited merely to the specific example embodiments of the foregoing description, but rather is indicated by the appended claims. All changes that come within the meaning and range of equivalents within the claims are to be considered as being embraced within the spirit and scope of the claims.

1. A press comprising:
a first motor that produces mechanical movement;
a second motor that produces mechanical movement; and
a transmission configured to convey mechanical movement to a ram from mechanical movement received by the transmission from at least the first motor, the conveying being responsive to mechanical movement received by the transmission from the second motor;
wherein the second motor is configured to provide mechanical movement that is controllably variable during a pressing cycle.

2. The press according to claim 1, wherein the first motor is configured to produce mechanical movement that is not controllably variable during a pressing cycle.

3. The press according to claim 2, wherein the second motor is a dynamically controllable variable-speed motor.

4. The press according to claim 1, wherein the first motor is a constant speed motor.

5. The press according to claim 1, wherein the second motor is a servomotor.

6. The press according to claim 1, wherein the second motor is less powerful than the first motor.

7. The press according to claim 1, further comprising a flywheel coupled to the transmission to help handle impulsive power demands on the first motor.

8. The press according to claim 1, wherein the transmission is configured to convey mechanical movement to the ram also from mechanical movement received from the second motor, the conveying being responsive to mechanical movement received by the transmission from the second motor.

9. The press according to claim 1, wherein the transmission comprises a multi-bar mechanism.

10. The press according to claim 1, wherein the second motor is programmatically controlled, wherein the trajectory of the ram can be established programmatically and without disassembly or replacement of any portion of the press.

11. A transmission for a mechanical press, the transmission comprising:
a first transmission for receiving mechanical movement from a first motor and to transmit mechanical movement to a ram; and
coupled to the first transmission, a second transmission for modifying configuration of the first transmission in response to mechanical movement received from a second motor wherein a profile of movement of the ram over a pressing cycle is affected by a profile of movement from the second motor over the pressing cycle.

12. The transmission according to claim 11, wherein the first transmission comprises a multi-bar mechanism.

13. The transmission according to claim 12, wherein the second transmission changes the geometry of the multi-bar mechanism of the first transmission.

14. A method for performing a pressing operation, comprising the acts of:
providing a first mechanical motion;
conveying mechanical energy from at least the first mechanical motion to a ram via a transmission configuration; and
providing a controllable second mechanical motion that alters the transmission configuration to control the motion characteristics of the ram, the second mechanical motion being distinct from the first mechanical motion.

15. The method according to claim 14, wherein the first mechanical motion is provided by a first motor, and the second mechanical motion is provided by a second motor.

16. The method according to claim 15, wherein speed of the first mechanical motion is not controllably variable, and the second mechanical motion controllably varies in speed during a single pressing cycle.

17. A method for constructing at least a portion of a mechanical press, the method comprising the acts of:
providing a first transmission configured to receive mechanical movement from a first motor and to transmit mechanical movement to a ram; and
providing a second transmission configured to modify configuration of the first transmission in response to mechanical movement received from a second motor wherein a profile of movement of the ram over a pressing cycle would be affected by a profile of movement from the second motor over the pressing cycle.
